(19) United States
(12) Patent Application Publication
(10) Pub. No.: US 2005/0062179 A1
(43) Pub. Date: Mar. 24, 2005

(54) Automated method for transferring lenses in a hydrated state from molds to receivers

(76) Inventors: Sanjay Rastogi, Rochester, NY (US); Matthew F. Tavino, Rochester, NY (US); Marie E. Simonds, Scottsville, NY (US); Barry B. Moore, Webster, NY (US)

Correspondence Address: Bausch & Lomb Incorporated, One Bausch & Lomb Place, Rochester, NY, 14604-2701, US

(21) Appl. No.: 10/667,944

(22) Filed: Sep. 22, 2003

(51) Int. Cl. B29D 11/00

(52) U.S. Cl. 264/1.1; 264/334

(57) ABSTRACT

To break up high surface tension forces between an amorphous lens mold and a hydrated lens, a precise x-and-y-coordinate motion tangential to the lens surface is used in combination with a z-coordinate motion using the vacuum of a lens pick and place robot. The sequence of motions permits the transfer of lenses in an automated fashion from the molding step to a subsequent process in a robust and accurate manner, thereby minimizing lens-handling defects.

### FIELD OF THE INVENTION

This invention relates to the manufacture of intraocular and contact lenses, and more specifically to methods of removing hydrophilic lenses and lens systems from their fabrication molds.

### BACKGROUND OF THE INVENTION

Hydrophilic contact and intraocular lenses may be molded and hydrated in an amorphous mold. One conventional lens removal process for hydrophilic lenses is to simply apply a vacuum to a free face of the lens to draw the lens away from the mold. The presence of water in both the mold and the lens creates a strong surface tension between the surface of the lens and the surface of the mold. The surface tension works to retain the lens in the mold against efforts to extract the lens for further steps in manufacture. Due to the fragility of hydrophilic contact lenses, the stress caused by the vacuum working against the surface tension can damage or destroy the lens.

### SUMMARY OF THE INVENTION

The invention breaks up high surface tension forces between an amorphous lens mold and a hydrated lens by introducing a precise x-and-y-coordinate motion tangential to the lens surface in combination with a z-coordinate motion using the vacuum of a lens pick and place robot. The sequence of motions permits the transfer of lenses in an automated fashion from the molding step to a subsequent process in a robust and accurate manner, thereby minimizing lens-handling defects.

### BRIEF DESCRIPTION OF THE DRAWINGS

FIG. 1A depicts a convex mold section, a lens, and the vacuum head of a pick and place robot, in an initial position.

FIG. 1B depicts a convex mold section, a lens, and the vacuum head of a pick and place robot, after a first movement (x-coordinate movement) tangential to the lens surface.

FIG. 2A shows a schematized concave mold section, a lens, and the vacuum head of a pick and place robot, in an initial position.

FIG. 2B shows a schematized concave mold section, a lens, and the vacuum head of a pick and place robot, after a first movement (x-coordinate movement) tangential to the lens surface.

FIG. 3 depicts a mold section, a lens, and the vacuum head of a pick and place robot, after a second movement (y-coordinate movement) tangential to the lens surface.

FIG. 4 depicts a mold section, a lens, and the vacuum head of a pick and place robot, after a third movement (z-coordinate movement) normal to the lens surface.

FIGS. 5A through 5E show the edge of a lens in stages of motion across a mold surface, with a water molecular layer between lens and mold.

FIG. 6 shows a lens being moved in a single direction across a mold surface.

FIG. 7 shows a lens being moved in a sequence of two different directions across a mold surface.

FIGS. 8A through 8D show four different possible combinations of patterns of motion, including lens rotation, for a lens across a mold surface.

FIGS. 9A through 9D show four different possible combinations of patterns of motion, not including lens rotation, for a lens across a mold surface.

FIGS. 10A and 10B show two possible patterns of lens rotation for a lens on a mold surface.

### DETAILED DESCRIPTION OF THE INVENTION

Without risking lens damage, the invention overcomes the surface tension force existing between the hydrophilic contact lenses and the female (anterior) amorphous mold surface after hydration of the lenses in the same amorphous material. The invention overcomes the surface tension force by imparting a precise mechanical movement in the x and y coordinates (a swiping x-coordinate and y-coordinate motion tangential to the mold surface), together with a removal force (a z-coordinate motion, normal to and directed away from the mold surface) provided by the vacuum head of a pick and place robot. The x and y motions of the pick head are accomplished by the use of a servo motor whereas the vacuum is generated by a separate vacuum line. The result duplicates the movements used in the manual picking up of the lenses with a forefinger from the amorphous mold surface after hydration.

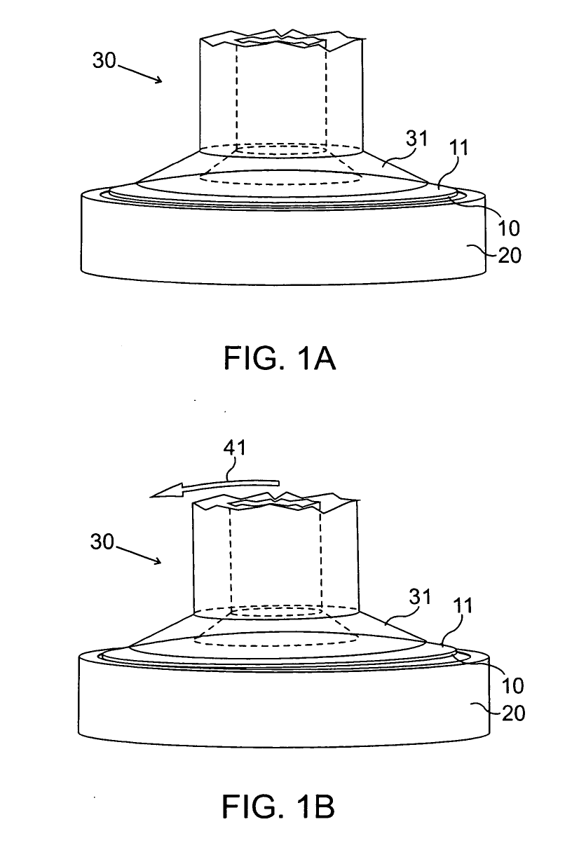

FIG. 1A shows a conceptual view of a vacuum head 30 of a pick and place robot, a convex lens 10, and a lens mold component 20. Vacuum head 30 has a silicone rubber nozzle 31 which engages with the surface of lens 10 resting on mold 20. The pick and place robot is capable of moving vacuum head 30 in x-, y-, and z-coordinate directions at varying rates of speed. The pick and place robot is also capable of rotating vacuum head 30 around the cylindrical axis of vacuum head 30.

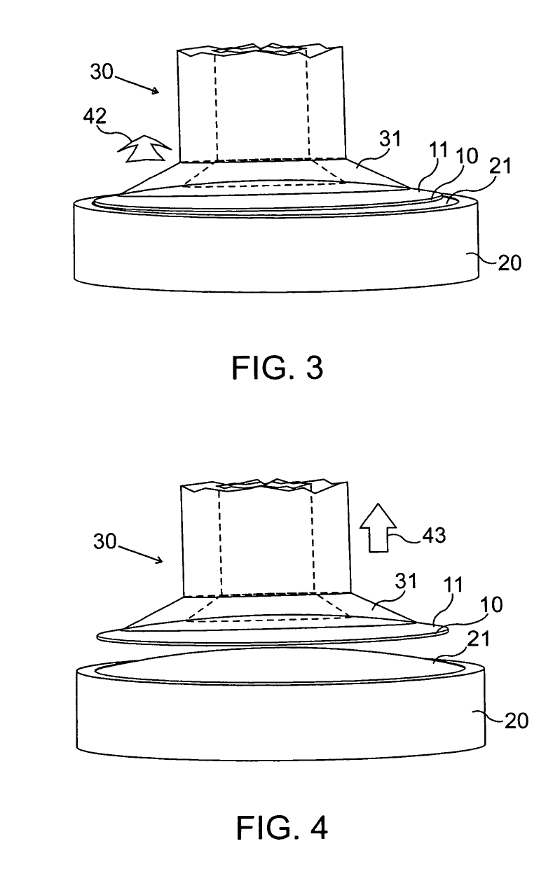

In FIGS. 1A, 1B, 3, and 4, a convex lens surface 11 is shown engaging with silicone rubber nozzle 31 of vacuum head 30. The invention's silicone rubber nozzle 31 is capable of engaging effectively with lens surfaces of convex, concave, or complex curvatures. The invention may be used effectively with all lenses of convex, concave, or complex curvatures. FIGS. 1A, 1B, 3, and 4 show a basic sequence of steps in removing a lens 10 from a mold 20. FIG. 1A shows the initial engagement of silicone rubber nozzle 31 of vacuum head 30 with lens 10, so that the vacuum of nozzle 31 holds lens 10 fixedly, and the pick and place robot can impart movement forces to lens 10. FIG. 1B shows the first movement 41 in the x-direction of vacuum head 30 with lens 10, tangentially to the surface 21 of mold 20. FIG. 3 shows the second movement 42 in the y-direction of vacuum head 30 with lens 10, tangentially to the surface 21 of mold 20 and at a sharp angle to first movement 41. FIG. 4 shows the third movement 43 in the z-direction of vacuum head 30 with lens 10, normal to and away from the surface 21 of mold 20, removing lens 10 from mold 20.

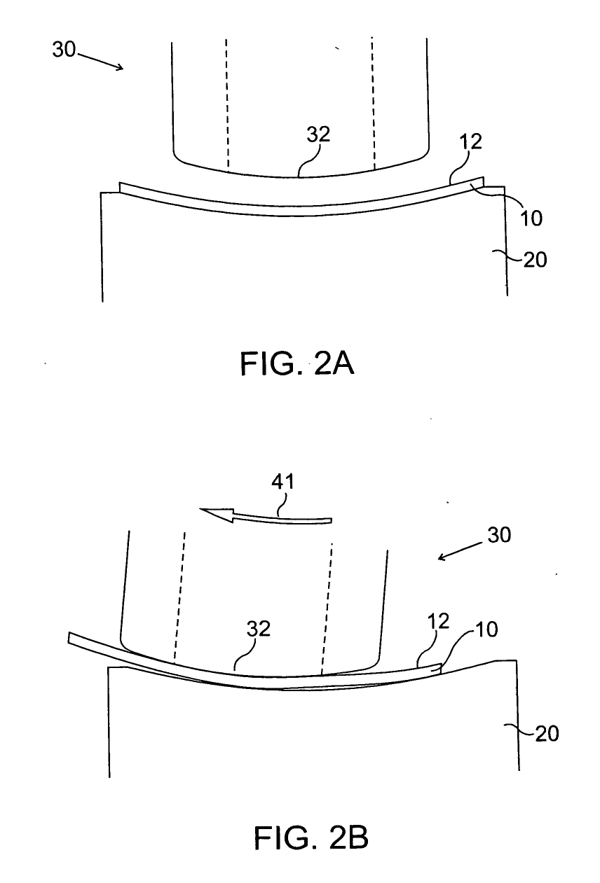

Schematic FIGS. 2A and 2B show the same sequence as in FIGS. 1A and 1B respectively, but for a concave lens surface 12 engaging with convex silicone rubber nozzle 32 of vacuum head 30.

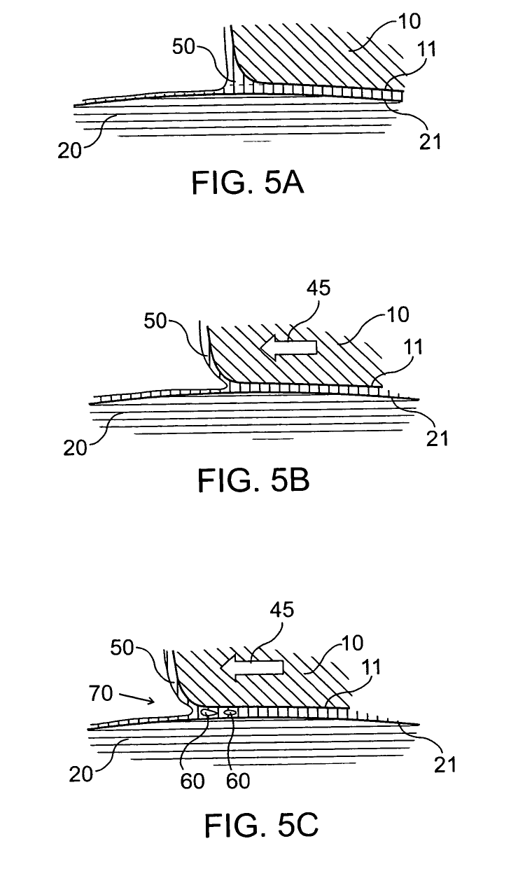

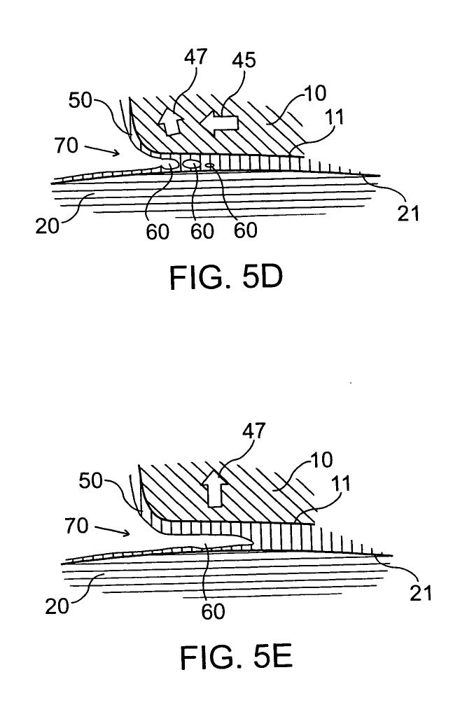

For a cutaway, detailed illustration of the invention's operation, see FIGS. 5A-5E. In FIG. 5A, a hydrated lens 10 rests on a mold surface 21 with a thin layer 50 of water molecules between lens surface 11 and mold surface 21. The pick and place robot (not shown) imparts a lateral movement 45 to lens 10 across mold surface 21, as seen in FIG. 5B. As lateral movement 45 continues, layer 50 of water molecules becomes thinner due in part to tensile force drawing water 50 into gap 70 between lens surface 11 and mold surface 21, and due in part to tensile force retaining water 50 at lens surface 11. As water layer 50 becomes thinner, a small amount of air 60 is trapped between lens surface 11 and mold surface 21, as shown in FIG. 5C.

The presence of small amount of air 60 between lens surface 11 and mold surface 21 weakens the tensile force drawing lens surface 11 and mold surface 21 together with water 50 between them. As shown in FIG. 5D, the pick and place robot applies a vertical tensile force to lens 10 as lateral movement 45 continues, making lens 10 begin a vertical movement 47 away from mold 20, and moving more air 60 into gap 70, accelerating the reduction of the tensile force between lens surface 11 and mold surface 21. Gap 70 widens until lens 10 and mold 20 can be separated easily, as shown in FIG. 5E.

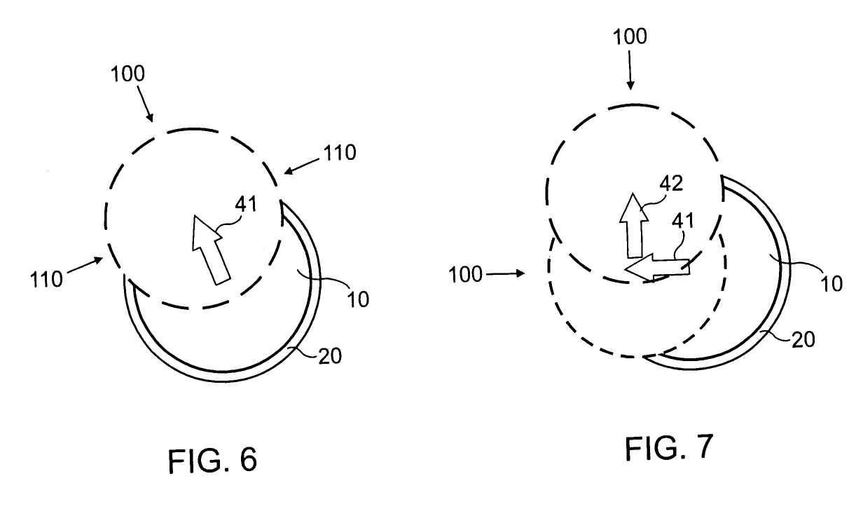

FIGS. 5A-5E show a simple x-movement of the lens. FIGS. 6 and 7 show plan views of lens 10 and mold 20. FIG. 6 shows lens 10 in a linear exaggerated xy-plane motion 41 according to one step of the invention. As shown in FIGS. 6 and 5A-5E, the speed of edge movement of lens 10 relative to air 60 and mold surface 21 varies from a maximum at leading point 100 of lens 10 to zero at side points 110 of lens 10. At slower rates of movement, water layer 50 can move to thicken before tensile forces between lens surface 11 and mold surface 21 can thin water layer 50 sufficiently to trap air 60 between lens 10 and mold surface 21.

FIG. 7 shows lens 10 in two exaggerated linear xy-plane motions 41 at a sharp angle to each other according to two steps of the invention. Preferred embodiments of the invention combine both x-movement 41 and y-movement 42 of lens 10 in rapid sequence as shown in FIG. 7, thereby maximizing the speed of edge movement of lens 10 relative to air 60 and mold surface 21 along a greater edge distance, thinning water layer 50 to a greater extent than shown in FIG. 6, introducing more air 60 between lens surface 11 and mold surface 21 and further weakening the tensile forces holding lens 10 and mold surface 21 together.

In the invention's production process, the molds and hydrated lens assembly are held in place by a metallic belt with nubs over which a mold is placed with enough clearance to sway in conjunction with the imparting x and y movements of the robot. The invention enables the complete automation of the process, thereby eliminating manual operations and providing a more robust process in terms of lens transfer, repeatability, and handling rejects incurred.

### DESCRIPTION OF PROCESS

The female amorphous molds with the cured lenses are placed on the metallic belt with nubs in arrays of 10 or more. These lenses are then hydrated by precise exposure to water and heat. Once the lenses are hydrated, a pick and place robot transfers the lenses to a subsequent process. The pick and place robot combines an x-and-y-coordinate motion, which is a swiping motion that slides the lens a short distance across the mold surface, with a vacuum pulling in the z-coordinate direction to lift the lens away from the mold. This combination of motions sets the lens free from the female anterior molds by breaking the existing surface tension forces. The indexing motion of the metallic belt with nubs acts as a mode of transport of the mentioned female mold and lens assembly from curing to the pick and place robot. To achieve compliance and conformance to the shapes of concave molds and hydrated lenses with different profiles (various sku's), the invention uses a silicone rubber nozzle of a specific durometer reading for applying the vacuum and moving the lens.

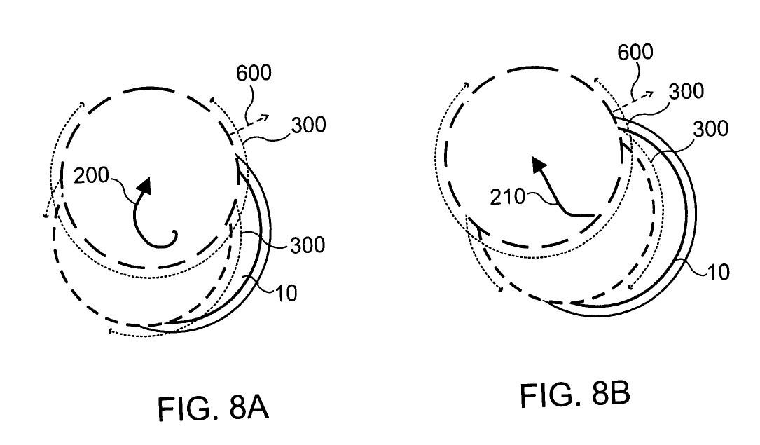

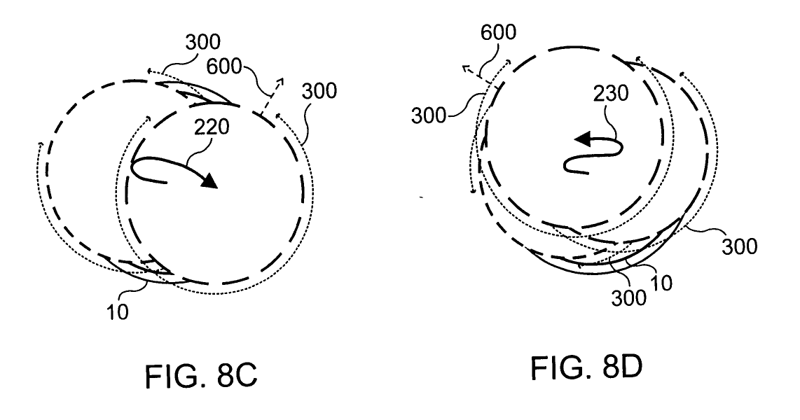

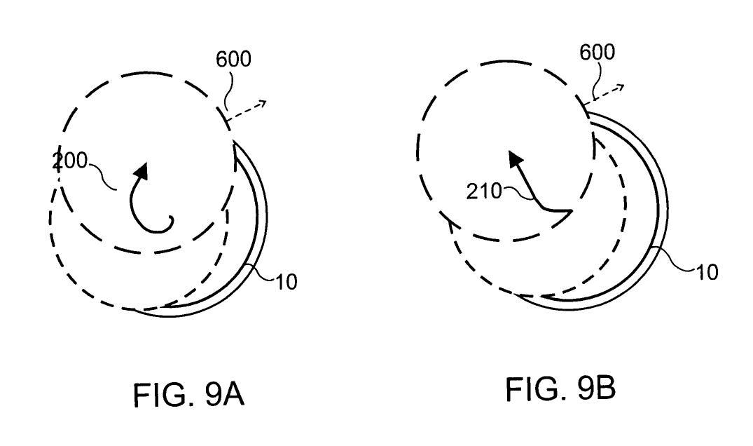

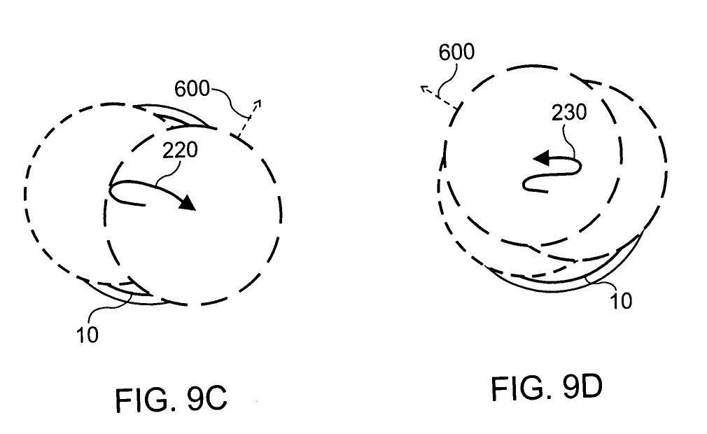

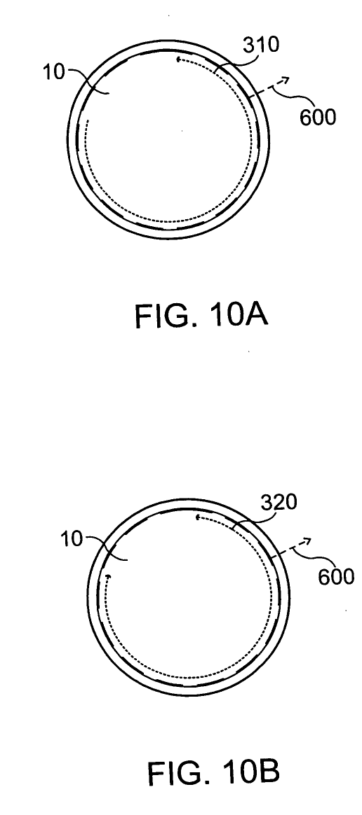

Different embodiments of the invention use different combinations of movement directions, durations, speeds, and accelerations. In a preferred first set of embodiments of movement, shown in FIGS. 8A-8D, lens 10 is both swiped in a motion 200 (FIG. 8A), 210 (FIG. 8B), 220 (FIG. 8C), or 230 (FIG. 8D) and rotated around an axis normal to its surface in a motion 300 in the x-y plane to facilitate removal 600. In a second set of embodiments of movement, shown in FIGS. 9A-9D, lens 10 is moved in a swiping motion 200 (FIG. 9A), 210 (FIG. 9B), 220 (FIG. 9C), or 230 (FIG. 9D) as in the first set of embodiments without rotation around an axis normal to its surface but providing both x- and y-coordinate movement. In a third set of embodiments of movement, shown in FIGS. 10A and 10B, lens 10 is rotated around an axis normal to its surface in the x-y plane in a motion 310 in one direction or a motion 320 in both directions, without a swiping motion. In a fourth set of embodiments of movement, not shown, the lens is swiped laterally in only one direction, back and forth.

The rotation of lens 10 as shown in FIGS. 8A through 8D and 10A and 10B adds relative movement between lens and mold. This relative movement is most rapid at the periphery of the lens, and contributes to the weakening of tensile force between lens and mold, easing the process of separation of lens and mold.

The invention's combinations of lens rotations in the x-y plane, lens swiping movements in the x-y plane, and z-axis lens removal motions may take any form or sequence which reduces significantly the work done by z-axis removal motions against the tensile forces between the lens and the mold.

### IMPLEMENTATION

To optimize the autohydration process and establish pick yields in the range of high 80% to low 90% for bifocal lenses across extreme powers, the process was implemented in a test form.

A previously-used baseline protocol for hydration resulted in poor pick yields for low minus sku bifocal lenses ˜66% to 70%. For the bifocal program, the target for pick yields and for autohydration is high 80% to low 90%. This pick yield range results in a yield to stock of 71% to meet an acceptable unit cost target per lens. Advantages to autohydration include the elimination of labor, the reduction of lens unit cost, and the minimization of manual handling of the lens. It was therefore important to optimize this process to achieve the required proposed pick yield targets.

The lenses for the test were cast using PVC molds (both anterior and posterior), decapped in the lab, and then autohydrated.

Some of the major autohydration parameters for the optimized process are listed in Table 1. These parameter settings are generally used for low minus HEMA (2-hydroxyethyl methacrylate) product.

A back-and-forth swiping motion for the nozzle pick head, in a plane tangential to the mold-lens interface, was introduced in place of a vertical motion normal to the mold-lens interface. The swiping motion breaks the surface tension between the molds and the lens thereby enabling the picking of the lenses by vacuum through the nozzle coupled with a tensile force normal to the mold-lens interface.

A HEMA control lot for a low minus sku was run prior to optimization in order to verify the autohydration pick yields. For the control lot, the Sku was −3.00D, the sample size was 1160 lenses, and the pick yield was 98.4%

The pick yield percentages for the optimization runs, using autohydration with the swiping motion, appear in Tables 2 and 3.

The optimization pick yields compared well to the control HEMA pick yields for low minus Skus, and were in the high 80% and low 90% range for other Skus tested.

The rates of major defects seen for the Skus tested appear in Table 4. These defects are “pits/pits filled” and “no lens in molds”.

Table 5 compares various defects that could potentially be caused at autohydration. The defects listed for bifocal autohydration process are in line with the other products and processes.

The autohydration process together with the swiping pick head movement met the required target pick yields of high 80% to low 90% for the bifocal lenses and compared well with the control autohydration process in the low minus category. The defects related to autohydration also compared well (less than 2% for each defect type) with both the control HEMA product and the Bifocal product manufactured using manual hydration.

TABLE 1
Major Autohydration Parameters

| Autohydration parameters | Value |
|---|---|
| Air pressure at lens pick up and place | 40 ± 10-5 psi |
| Water mold fill | 375 μl-425 μl |
| Oven Temp | 200 C. |
| Oven load | every other flight |
| Oven time | 7-11 mins. |
| Inserts used in nozzles | Yes |

TABLE 2
Pick Yield and Pick Loss for 8.5 mm BC Design

| | | |
|---|---|---|
| Sku Description | Pick Yield % | Pick Loss % |

Low Minus Sku

| | | |
|---|---|---|
| −0.50 D (Low Add) | 96.2 | 3.8 |
| −3.25 D (Low Add) | 98.3 | 1.7 |
| −4.00 D (Low Add) | 95.3 | 4.7 |
| Avg. | 96.6 | 3.4 |

High Minus Sku

| | | |
|---|---|---|
| −10.00 D (Low Add) | 91.6 | 8.4 |
| −10.00 D (Low Add) | 84.6 | 15.4 |
| Avg. | 88.1 | 11.9 |

Low Plus Sku

| | | |
|---|---|---|
| +1.25 D (Low Add) | 96.0 | 4.0 |
| +1.50 D (Low Add) | 97.8 | 2.2 |
| Avg. | 96.9 | 3.1 |

High Plus Sku

| | | |
|---|---|---|
| +6.00 D (High Add) | 96.2 | 2.8 |
| Overall Avg.(all categories combined) | 94.5 | 5.4 |

TABLE 3
Pick Yield and Pick Loss for 8.8 mm BC Design

| | | |
|---|---|---|
| Sku Description | Pick Yield % | Pick Loss % |

Low minus Sku

| | | |
|---|---|---|
| −1.00 D (High Add) | 98.2 | 1.8 |
| −2.00 D (High Add) | 90.2 | 9.8 |
| −3.00 D (High Add) | 84.8 | 15.2 |
| Avg. | 91.1 | 8.9 |

High Minus Sku

| | | |
|---|---|---|
| — | — | — |

Low Plus Sku

| | | |
|---|---|---|
| +1.00 D (Low Add) | 99.7 | 0.3 |

High Plus Sku

| | | |
|---|---|---|
| — | — | — |
| Overall Avg.(all categories combined) | 93.2 | 6.8 |

TABLE 4
Main defects

| Defect Type | Overall Average % | Range % |
|---|---|---|
| Pits/Pits Filled | 51 | 16% to 71% |
| No Lens in molds | 14 | 1% to 32% |

TABLE 5
Comparison of defects potentially caused by Autohydration

| | | | SVS Hema |
|---|---|---|---|
| | | | Lab - Manual |
| Defect Type | Bifocal-AH % | SVS Hema-AH % | Hydration % |
| Rough surface(RS) | 0.8 | 0.6 | 0.3 |
| Puncture | 1.8 | <1% | 0.4 |
| Tear | 0.1 | <1% | 1 |

Having described one or more embodiments, those skilled in the art understand that additions, deletions, and modifications of the elements and steps of the invention may be made without departing from its spirit and scope as set forth in the appended claims.

1. A method for removing a hydrated contact lens from a mold, comprising the steps of:
moving the lens in a pattern tangential to the surface of the lens still adhering to the mold; and
applying sufficient force on the lens normal to and away from the mold to separate the lens from the mold.

2. The method of claim 1, wherein the step of moving the lens in a pattern tangential to the surface of the lens still adhering to the mold further comprises the steps of:
moving the lens in a first linear direction tangential to the surface of the lens;
moving the lens in a second linear direction tangential to the surface of the lens and at a large angle to the first linear direction; and
rotating the lens around an axis normal to the lens surface.

3. The method of claim 1, wherein the step of moving the lens in a pattern tangential to the surface of the lens still adhering to the mold further comprises the steps of:
moving the lens in a first linear direction tangential to the surface of the lens; and
moving the lens in a second linear direction tangential to the surface of the lens and at a large angle to the first linear direction.

4. The method of claim 1, wherein the step of moving the lens in a pattern tangential to the surface of the lens still adhering to the mold further comprises the step of moving the lens in a linear direction tangential to the surface of the lens.

5. The method of claim 1, wherein the step of moving the lens in a pattern tangential to the surface of the lens still adhering to the mold further comprises the steps of:
moving the lens in a series of distinct linear directions tangential to the surface of the lens; and
rotating the lens around an axis normal to the lens surface.

6. The method of claim 1, wherein the step of moving the lens in a pattern tangential to the surface of the lens still adhering to the mold further comprises the steps of:
moving the lens in a series of changing and recurring linear directions tangential to the surface of the lens; and
rotating the lens around an axis normal to the lens surface.

7. The method of claim 1, wherein the step of moving the lens in a pattern tangential to the surface of the lens still adhering to the mold further comprises the step of rotating the lens around an axis normal to the lens surface.

8. The method of claim 1, wherein the step of moving the lens in a pattern tangential to the surface of the lens still adhering to the mold further comprises the steps of:
rotating the lens around an axis normal to the lens surface; and
moving the lens in a series of distinct linear directions tangential to the surface of the lens.

9. The method of claim 1, wherein the step of moving the lens in a pattern tangential to the surface of the lens still adhering to the mold further comprises the steps of:
rotating the lens around an axis normal to the lens surface; and
moving the lens in a series of changing and recurring linear directions tangential to the surface of the lens.

10. The method of claim 1, wherein the step of moving the lens in a pattern tangential to the surface of the lens still adhering to the mold further comprises the steps of:
rotating the lens around an axis normal to the lens surface while moving the lens in a series of distinct linear directions tangential to the surface of the lens.

11. The method of claim 1, wherein the step of moving the lens in a pattern tangential to the surface of the lens still adhering to the mold further comprises the steps of:
rotating the lens around an axis normal to the lens surface while moving the lens in a series of changing and recurring linear directions tangential to the surface of the lens.

12. The method of claim 1, wherein the step of applying sufficient force on the lens normal to and away from the mold to separate the lens from the mold comprises applying sufficient vacuum on the lens normal to and away from the mold to separate the lens from the mold.

13. A method for removing a hydrated contact lens from a mold, comprising the steps of:
moving the lens in a pattern tangential to the surface of the lens still adhering to the mold while applying sufficient force on the lens normal to and away from the mold to separate the lens from the mold.

14. The method of claim 13, wherein the step of moving the lens in a pattern tangential to the surface of the lens still adhering to the mold while applying sufficient force on the lens normal to and away from the mold to separate the lens from the mold comprises moving the lens in a pattern tangential to the surface of the lens still adhering to the mold while applying sufficient vacuum on the lens normal to and away from the mold to separate the lens from the mold.

15. The method of claim 14, wherein the step of moving the lens in a pattern tangential to the surface of the lens still adhering to the mold while applying sufficient vacuum on the lens normal to and away from the mold to separate the lens from the mold further comprises the steps of:
moving the lens in a first linear direction tangential to the surface of the lens;
moving the lens in a second linear direction tangential to the surface of the lens and at a large angle to the first linear direction; and
rotating the lens around an axis normal to the lens surface.

16. The method of claim 14, wherein the step of moving the lens in a pattern tangential to the surface of the lens still adhering to the mold while applying sufficient vacuum on the lens normal to and away from the mold to separate the lens from the mold further comprises the steps of:
moving the lens in a first linear direction tangential to the surface of the lens; and
moving the lens in a second linear direction tangential to the surface of the lens and at a large angle to the first linear direction.

17. The method of claim 14, wherein the step of moving the lens in a pattern tangential to the surface of the lens still adhering to the mold while applying sufficient vacuum on the lens normal to and away from the mold to separate the lens from the mold further comprises the step of moving the lens in a linear direction tangential to the surface of the lens.

18. The method of claim 14, wherein the step of moving the lens in a pattern tangential to the surface of the lens still adhering to the mold while applying sufficient vacuum on the lens normal to and away from the mold to separate the lens from the mold further comprises the steps of:
moving the lens in a series of distinct linear directions tangential to the surface of the lens; and
rotating the lens around an axis normal to the lens surface.

19. The method of claim 14, wherein the step of moving the lens in a pattern tangential to the surface of the lens still adhering to the mold while applying sufficient vacuum on the lens normal to and away from the mold to separate the lens from the mold further comprises the steps of:
moving the lens in a series of changing and recurring linear directions tangential to the surface of the lens; and
rotating the lens around an axis normal to the lens surface.

20. The method of claim 14, wherein the step of moving the lens in a pattern tangential to the surface of the lens still adhering to the mold while applying sufficient vacuum on the lens normal to and away from the mold to separate the lens from the mold further comprises the step of rotating the lens around an axis normal to the lens surface.

21. The method of claim 14, wherein the step of moving the lens in a pattern tangential to the surface of the lens still adhering to the mold while applying sufficient vacuum on the lens normal to and away from the mold to separate the lens from the mold further comprises the steps of:
rotating the lens around an axis normal to the lens surface; and
moving the lens in a series of distinct linear directions tangential to the surface of the lens.

22. The method of claim 14, wherein the step of moving the lens in a pattern tangential to the surface of the lens still adhering to the mold while applying sufficient vacuum on the lens normal to and away from the mold to separate the lens from the mold further comprises the steps of:
rotating the lens around an axis normal to the lens surface; and
moving the lens in a series of changing and recurring linear directions tangential to the surface of the lens.

23. The method of claim 14, wherein the step of moving the lens in a pattern tangential to the surface of the lens still adhering to the mold while applying sufficient vacuum on the lens normal to and away from the mold to separate the lens from the mold further comprises the steps of:
rotating the lens around an axis normal to the lens surface while moving the lens in a series of distinct linear directions tangential to the surface of the lens.

24. The method of claim 14, wherein the step of moving the lens in a pattern tangential to the surface of the lens still adhering to the mold while applying sufficient vacuum on the lens normal to and away from the mold to separate the lens from the mold further comprises the steps of:
rotating the lens around an axis normal to the lens surface while moving the lens in a series of changing and recurring linear directions tangential to the surface of the lens.

25. A method for removing a hydrated contact lens from a mold, comprising the steps of:
applying sufficient vacuum to an exposed face of the lens to hold the lens securely;
moving the lens in a pattern tangential to the surface of the lens still adhering to the mold; and
applying sufficient force on the lens normal to and away from the mold to separate the lens from the mold.

26. The method of claim 25, wherein the step of moving the lens in a pattern tangential to the surface of the lens still adhering to the mold further comprises the steps of:
moving the lens in a first linear direction tangential to the surface of the lens;
moving the lens in a second linear direction tangential to the surface of the lens and at a large angle to the first linear direction; and
rotating the lens around an axis normal to the lens surface.

27. The method of claim 25, wherein the step of moving the lens in a pattern tangential to the surface of the lens still adhering to the mold further comprises the steps of:
moving the lens in a first linear direction tangential to the surface of the lens; and
moving the lens in a second linear direction tangential to the surface of the lens and at a large angle to the first linear direction.

28. The method of claim 25, wherein the step of moving the lens in a pattern tangential to the surface of the lens still adhering to the mold further comprises the step of moving the lens in a linear direction tangential to the surface of the lens.

29. The method of claim 25, wherein the step of moving the lens in a pattern tangential to the surface of the lens still adhering to the mold further comprises the steps of:
moving the lens in a series of distinct linear directions tangential to the surface of the lens; and
rotating the lens around an axis normal to the lens surface.

30. The method of claim 25, wherein the step of moving the lens in a pattern tangential to the surface of the lens still adhering to the mold further comprises the steps of:
moving the lens in a series of changing and recurring linear directions tangential to the surface of the lens; and
rotating the lens around an axis normal to the lens surface.

31. The method of claim 25, wherein the step of moving the lens in a pattern tangential to the surface of the lens still adhering to the mold further comprises the step of rotating the lens around an axis normal to the lens surface.

32. The method of claim 25, wherein the step of moving the lens in a pattern tangential to the surface of the lens still adhering to the mold further comprises the steps of:
rotating the lens around an axis normal to the lens surface; and
moving the lens in a series of distinct linear directions tangential to the surface of the lens.

33. The method of claim 25, wherein the step of moving the lens in a pattern tangential to the surface of the lens still adhering to the mold further comprises the steps of:
rotating the lens around an axis normal to the lens surface; and
moving the lens in a series of changing and recurring linear directions tangential to the surface of the lens.

34. The method of claim 25, wherein the step of moving the lens in a pattern tangential to the surface of the lens still adhering to the mold further comprises the steps of:
rotating the lens around an axis normal to the lens surface while moving the lens in a series of distinct linear directions tangential to the surface of the lens.

35. The method of claim 25, wherein the step of moving the lens in a pattern tangential to the surface of the lens still adhering to the mold further comprises the steps of:
rotating the lens around an axis normal to the lens surface while moving the lens in a series of changing and recurring linear directions tangential to the surface of the lens.

36. The method of claim 25, wherein the step of applying sufficient force on the lens normal to and away from the mold to separate the lens from the mold comprises applying sufficient vacuum on the lens normal to and away from the mold to separate the lens from the mold.

37. A method for removing a hydrated contact lens from a mold, comprising the steps of:
exposing one face of the lens by removing one or more mold sections;
positioning a vacuum instrument over the exposed face of the lens;
applying sufficient vacuum to the exposed face of the lens to hold the lens securely;
moving the lens in a pattern tangential to the surface of the lens still adhering to the mold; and
applying sufficient force on the lens normal to and away from the mold to separate the lens from the mold.

38. The method of claim 37, wherein the step of moving the lens in a pattern tangential to the surface of the lens still adhering to the mold further comprises the steps of:
moving the lens in a first linear direction tangential to the surface of the lens;
moving the lens in a second linear direction tangential to the surface of the lens and at a large angle to the first linear direction; and
rotating the lens around an axis normal to the lens surface.

39. The method of claim 37, wherein the step of moving the lens in a pattern tangential to the surface of the lens still adhering to the mold further comprises the steps of:
moving the lens in a first linear direction tangential to the surface of the lens; and
moving the lens in a second linear direction tangential to the surface of the lens and at a large angle to the first linear direction.

40. The method of claim 37, wherein the step of moving the lens in a pattern tangential to the surface of the lens still adhering to the mold further comprises the step of moving the lens in a linear direction tangential to the surface of the lens.

41. The method of claim 37, wherein the step of moving the lens in a pattern tangential to the surface of the lens still adhering to the mold further comprises the steps of:
moving the lens in a series of distinct linear directions tangential to the surface of the lens; and
rotating the lens around an axis normal to the lens surface.

42. The method of claim 37, wherein the step of moving the lens in a pattern tangential to the surface of the lens still adhering to the mold further comprises the steps of:
moving the lens in a series of changing and recurring linear directions tangential to the surface of the lens; and
rotating the lens around an axis normal to the lens surface.

43. The method of claim 37, wherein the step of moving the lens in a pattern tangential to the surface of the lens still adhering to the mold further comprises the step of rotating the lens around an axis normal to the lens surface.

44. The method of claim 37, wherein the step of moving the lens in a pattern tangential to the surface of the lens still adhering to the mold further comprises the steps of:
rotating the lens around an axis normal to the lens surface; and
moving the lens in a series of distinct linear directions tangential to the surface of the lens.

45. The method of claim 37, wherein the step of moving the lens in a pattern tangential to the surface of the lens still adhering to the mold further comprises the steps of:
rotating the lens around an axis normal to the lens surface; and
moving the lens in a series of changing and recurring linear directions tangential to the surface of the lens.

46. The method of claim 37, wherein the step of moving the lens in a pattern tangential to the surface of the lens still adhering to the mold further comprises the steps of:
rotating the lens around an axis normal to the lens surface while moving the lens in a series of distinct linear directions tangential to the surface of the lens.

47. The method of claim 37, wherein the step of moving the lens in a pattern tangential to the surface of the lens still adhering to the mold further comprises the steps of:
rotating the lens around an axis normal to the lens surface while moving the lens in a series of changing and recurring linear directions tangential to the surface of the lens.

48. The method of claim 37, wherein the step of applying sufficient force on the lens normal to and away from the mold to separate the lens from the mold comprises applying sufficient vacuum on the lens normal to and away from the mold to separate the lens from the mold.
